(19) United States
(12) Patent Application Publication
(10) Pub. No.: US 2013/0314849 A1
(43) Pub. Date: Nov. 28, 2013

(54) Power Supply System

(71) Applicant: Power Logic South Africa (Pty) Ltd, Ottery (ZA)

(72) Inventors: Raymond Mazzullo, Constantia (ZA); Adrian Mazzullo, Noordehoek (ZA); Brian Van Zyl, Ottery (ZA); Bastian Strauf, Strand (ZA); Nicholas Brear, Ottery (ZA)

(21) Appl. No.: 13/902,311

(22) Filed: May 24, 2013

(30) Foreign Application Priority Data
May 28, 2012 (ZA) 2012/03877

(51) Int. Cl. H02B 1/04; H02B 1/015

(52) U.S. Cl. CPC H02B 1/04; H02B 1/015
USPC 361/631; 361/627

(57) ABSTRACT

A power supply system is disclosed which comprises a printed circuit board (10) having on one side of the substrate thereof a live track (58), a neutral track (54) and a switched live track (52). A switch (30) when closed connects the live track to the switched-live track (52). The tracks (52, 58) connect live input terminal (12) to a live output terminal (20) and a neutral input terminal (16) to a neutral output terminal (18). A second switched-live track connected to the track (58) is provided on the opposite side of the substrate.

### FIELD OF THE INVENTION

THIS INVENTION relates to a power supply system.

### BACKGROUND TO THE INVENTION

It has become commonplace to provide socket boxes with a number of sockets for receiving the plugs on the leads of products to which power is to be supplied. The plug pin receiving receptacles of the socket boxes are connected together and to the power supply using plastic covered wires. Wiring is labour intensive and hence contributes significantly to the cost of the product. In addition, to increase the power that the socket box can supply, the connecting wires have to be increased in size. They then become too stiff to manipulate with ease in the confines of the socket box.

### BRIEF DESCRIPTION OF THE INVENTION

According to the present invention there is provided a power supply system which comprises a printed circuit board having input terminals for the live and neutral cables which connect the system to a source of power, live and neutral output terminals for connection to the live and neutral plug pin receptacles of a socket box and electrically conductive live and neutral tracks on the surface of the electrically insulating substrate of the board which tracks connect the live input and output terminals to one another and the neutral input and output terminals to one another.

There can be a switch having a live terminal and a switched live terminal, said live track having a first part connecting said live terminal of the switch to the live input terminal and a second part which is a switched-live track connecting the switched-live terminal of the switch to the live output terminal.

In the preferred form there is a further switched-live track on the opposite side of said substrate to said switched-live track, the switched-live contact of the switch and the live output terminal being connected to the switched live tracks on both sides of said substrate of the printed circuit board.

There can be an additional track connecting an input earth cable terminal to an output earth terminal.

More than one live output terminal and more than one neutral output terminal connected to the respective track can be provided.

### BRIEF DESCRIPTION OF THE DRAWINGS

For a better understanding of the present invention, and to show how the same may be carried into effect, reference will now be made, by way of example, to the accompanying drawings in which:

FIG. 1 is pictorial view of the top face of a printed circuit board (PCB) in accordance with the present invention;

FIG. 2 is a pictorial view of the lower face of the PCB of FIG. 1;

FIG. 3 is a pictorial view similar to that of FIG. 1 but with a switch added and a number of plug pin receptacles omitted;

FIG. 4 is a pictorial view similar to that of FIG. 1 and additionally shows the lower parts of two sockets;

FIG. 5 is an underneath plan view of a fully assembled socket construction including two sockets and the power supply leads but omitting the switch;

FIG. 6 is a top plan view of the fully assembled socket construction but with the power leads omitted; and

FIG. 7 is an end view of a fully assembled socket box but omitting the power leads.

### DETAILED DESCRIPTION OF THE DRAWINGS

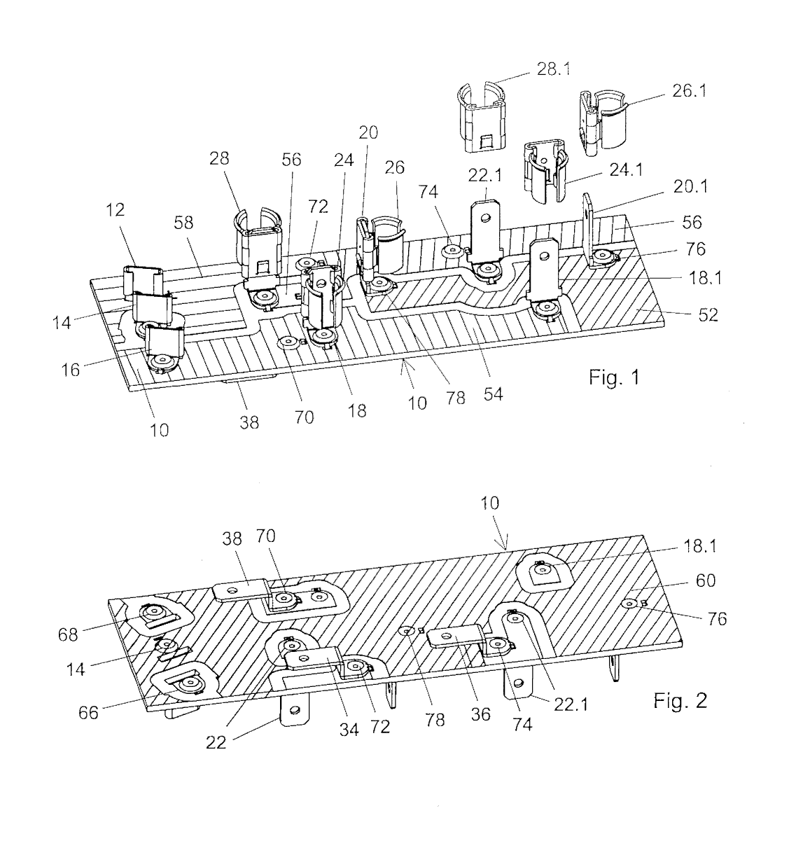

The printed circuit board illustrated in FIGS. 1 to 3 is designated 10 and will hereafter be referred to as the PCB10. At the left hand end of the PCB10 there are three terminals 12, 14 and 16, which are the live, switched live and neutral terminals respectively of the power supply.

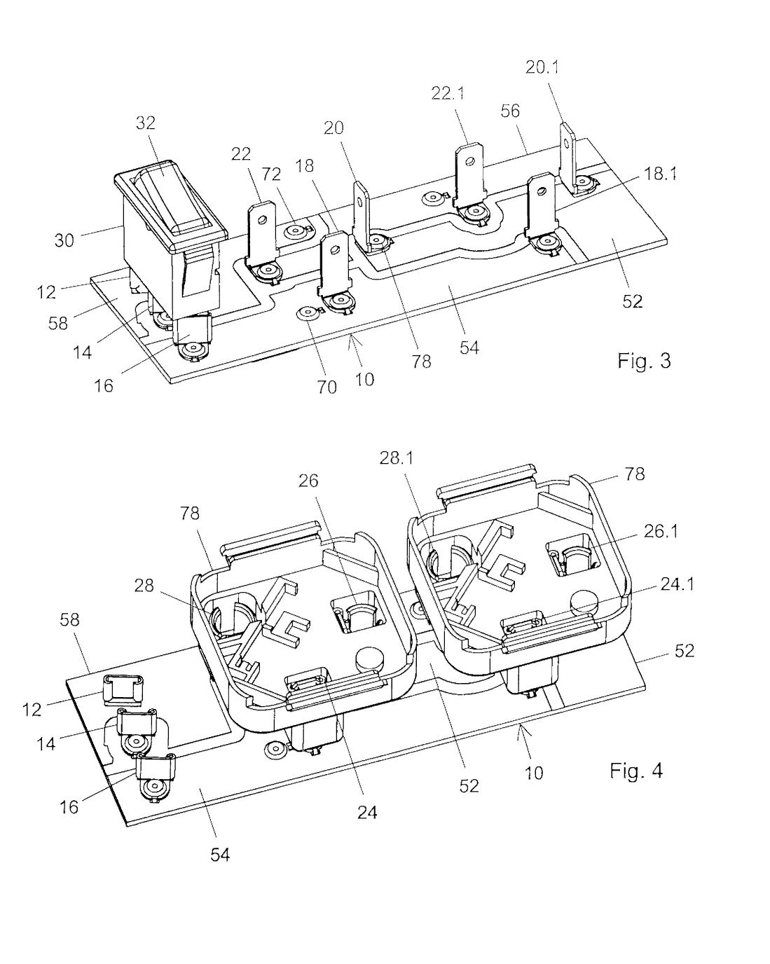

Two groups of vertical spade terminals project upwardly from the PCB 10. The terminals of the first group (see FIGS. 1 and 3) are a neutral terminal 18, a live terminal 20 and an earth terminal 22. The spade terminals of the second group are designated 18.1, 20.1 and 22.1.

Three plug pin receptacles 24, 26 and 28 are shown fitted to the terminals 18, 20 and 22. Three further receptacles 24.1, 26.1 and 28.1 are shown above the terminals 18.1, 20.1 and 22.1.

Each receptacle comprises a strip of copper bent to provide a generally rectangular slot for receiving one of the spade terminals and a generally circular socket for receiving a round section plug pin as will be described.

The terminals 12, 14 and 16 form part of a switch 30 (FIG. 3) which includes an operating rocker 32.

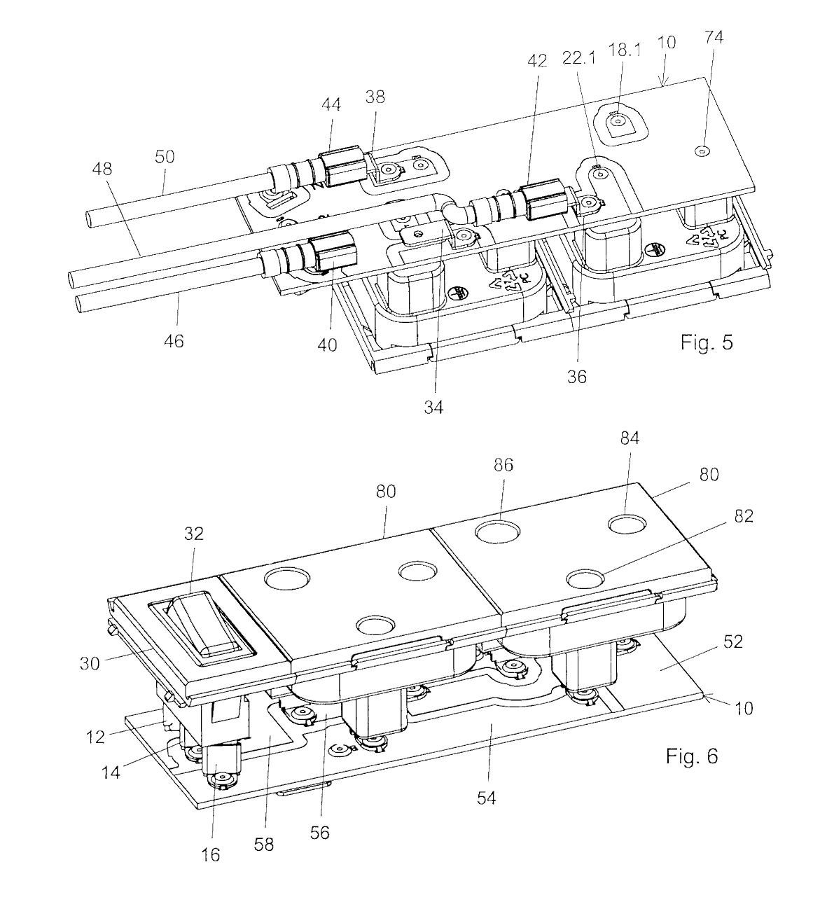

Referring now to FIG. 2 there are three horizontal spade terminals 34, 36 and 38 on the underside of the PCB10. Cable connectors 40, 42 and 44 (FIG. 5) secured to cables 46, 48 and 50 are pushed onto the spade terminals 34, 36 and 38 respectively. Purely for illustrative purposes the cable connector 40 is shown separated from the spade connector 34.

There are four copper tracks on the top surface of the PCB 10. The tracks are designated 52, 54, 56 and 58 and have been hatched in different ways to enable their configuration readily to be determined. The track 52 is the “switched live” track and the terminals 20 and 20.1 are within the area of this track. The track 54 is the neutral track and the terminals 18 and 18.1 are within the area of this track. The track 56 is the earth track, the terminals 22 and 22.1 being within the area of this track. The fourth track 58 is the live track and the live terminal 12 of the switch 30 is within the area of this track.

On the underside of the PCB 10 there is a single track 60. The swiched live terminal 14 of the switch 30 is within the area of this track.

The mountings 66, 68 of the live and neutral terminals 12 and 16 of the switch 30 also pass through the PCB 10, this being necessary to enable them to be securely mounted. They are however, insulated from the track 60 by bare portions of the PCB. Likewise, the spade terminals 18, 18.1, 22 and 22.1 pass through the PCB 10 but are isolated from the track 60 by bare portions of the PCB 10. In an alternative construction the four spade terminals 18, 18.1, 22 and 22.1 are mounted on the top surface of the PCB and do not pass through it.

The mounting 70 of neutral spade terminal 38 on the underside of the PCB passes through the PCB into the neutral track 54.

The mounting 72 of the live spade terminal 34 on the underside of the PCB connects to the live track 58. The mounting 74 of the spade terminal 36 on the underside of the PCB 10 passes through the board within the area of the track 56.

The track 52 on the top surface of the PCB is connected to the track 60 on the underside of the PCB 10 by the mountings 76 and 78 of the terminals 20 and 20.1.

In FIG. 4 the bodies 78 of two plug sockets are shown. In FIG. 6 the bodies 78 are shown as well as covers 80 with plug pin receiving holes 82, 84 and 86 in them. The receptacles 24, 26, 28, 24.1, 26.1 and 28.1 fit into recesses provided for them in the bodies 78. The spacing of the recesses is such that the rectangular slots of the receptacles register with the vertical spade terminals and the circular parts of the receptacles register with the holes 82, 84 and 86. Consequently, a three pin plug pushed into either socket enters the circular parts of the underlying receptacles.

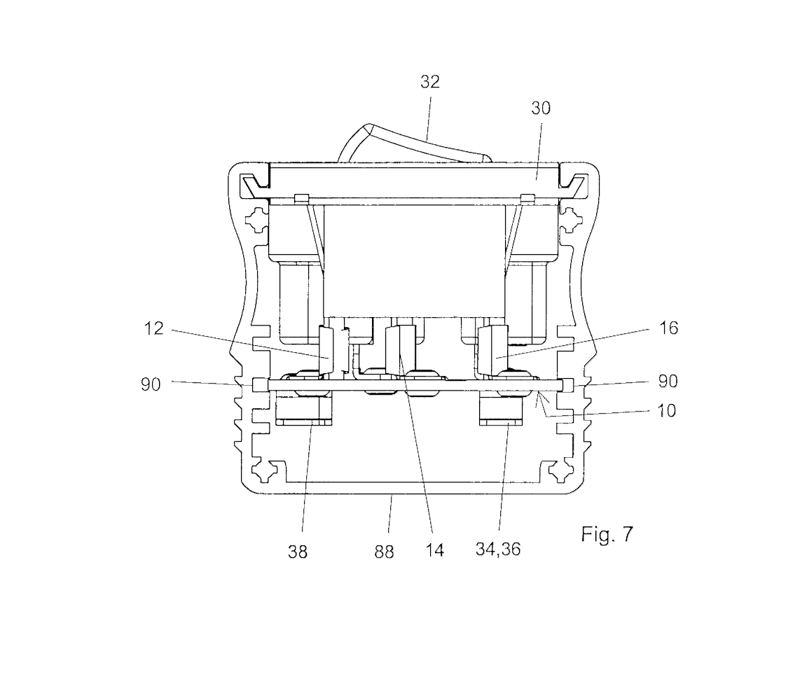

In FIG. 7 the power supply structure illustrated in FIGS. 1 to 6 is shown in an extruded casing 88. The edges of the PCB 10 are in slots 90 provided in the inner surfaces of the walls of the casing 88.

1. A power supply system which comprises a printed circuit board having input terminals for the live and neutral cables which connect the system to a source of power, live and neutral output terminals for connection to the live and neutral plug pin receptacles of a socket box and electrically conductive live and neutral tracks on the surface of the electrically insulating substrate of the board which tracks connect the live input and output terminals to one another and the neutral input and output terminals to one another.

2. A power supply system as claimed in claim 1 and including a switch having a live terminal and a switched live terminal, said live track having a first part connecting said live terminal of the switch to the live input terminal and a second part which is a switched-live track connecting the switched-live terminal of the switch to the live output terminal.

3. A power supply system as claimed in claim 2 and including a further switched-live track on the opposite side of said substrate to said switched-live track, the switched-live contact of the switch and the live output terminal being connected to the switched live tracks on both sides of said substrate of the printed circuit board.

4. A power supply system as claimed in claim 1 and including an additional track connecting an input earth cable terminal to an output earth terminal.

5. A power supply system as claimed in claim 2 and including an additional track connecting an input earth cable terminal to an output earth terminal.

6. A power supply system as claimed in claim 3 and including an additional track connecting an input earth cable terminal to an output earth terminal.

7. A power supply system as claimed in claim 1, and including more than one live output terminal and more than one neutral output terminal connected to the respective track.

8. A power supply system as claimed in claim 2, and including more than one live output terminal and more than one neutral output terminal connected to the respective track.

9. A power supply system as claimed in claim 3, and including more than one live output terminal and more than one neutral output terminal connected to the respective track.

10. A power supply system as claimed in claim 4, and including more than one live output terminal and more than one neutral output terminal connected to the respective track.
